(19) United States
(12) Patent Application Publication
(10) Pub. No.: US 2006/0262455 A1
(43) Pub. Date: Nov. 23, 2006

(54) Apparatus and method for forming a magnetic head coil in a compact area using damascene technology

(76) Inventors: David Patrick Druist, Santa Clara, CA (US); Edward Hin Pong Lee, San Jose, CA (US); Bradley Douglas Webb, San Jose, CA (US)

Correspondence Address: Maryam Imam, Esq.;LAW OFFICES OF IMAM, Suite 1010, 111 North Market Street, San Jose, CA, 95113, US

(21) Appl. No.: 11/496,947

(22) Filed: Jul. 31, 2006

Related U.S. Application Data
(63) Continuation-in-part of application No. 10/652,878, filed on Aug. 29, 2003, now Pat. No. 7,022,248.
(63) Continuation-in-part of application No. 10/652,877, filed on Aug. 29, 2003, now Pat. No. 7,075,750.

(51) Int. Cl. G11B 5/147

(52) U.S. Cl. 360/126

(57) ABSTRACT

In one embodiment of the present invention, a write head includes a P1 pedestal layer, a back gap layer, a coil formed between the P1 pedestal layer and the back gap layer, a hard bake photoresist formed above the P1 pedestal layer, and a hard bake photoresist barrier extending from and on either side of the P1 pedestal layer, wherein the hard bake photoresist barrier acts as a ‘dam’ for the hard bake photoresist to adhere to during manufacturing of the write head.

### CROSS REFERENCE TO RELATED APPLICATION

This application is a continuation-in-part of prior U.S. patent application Ser. No. 10/652,878, filed on Aug. 29, 2003, entitled “Method For Patterning A Self-Aligned Coil Using A Damascene Process”, by Bedell et al. and U.S. patent application Ser. No. 10/652,877, filed on Aug. 29, 2003, entitled “Apparatus For Patterning A Self-Aligned Coil Using A Damascene Process”, by Bedell et al., the disclosures of which are incorporated herein by reference, as though set forth in full.

### BACKGROUND OF THE INVENTION

1. Field of the Invention

This invention relates in general to the manufacture of magnetic heads, and more particularly to a method for forming a coil in a compact area of the magnetic head using a damascene process.

2. Description of Related Art

People need access to an increasing amount of information in our technologically-advancing society. Data storage using magnetic disk drives is well known and widely used because magnetic disk devices facilitate fast storage and access of large amounts of information. A typical disk drive is comprised of a magnetic recording medium in the form of a disk for storing information, and a magnetic read/write head for reading or writing information on the disk. The disk rotates on a spindle controlled by a drive motor and the magnetic read/write head is attached to a slider supported above the disk by an actuator arm. When the disk rotates at high speed a cushion of moving air is formed lifting the air bearing surface (ABS) of the magnetic read/write head above the surface of the disk.

As disk drive technology progresses, more data is compressed into smaller areas. Increasing data density is dependent upon read/write heads fabricated with smaller geometries capable of magnetizing or sensing the magnetization of correspondingly smaller areas on the magnetic disk. The advance in magnetic head technology has led to heads fabricated using processes similar to those used in the manufacture of semiconductor devices.

The read portion of the head is typically formed using a magnetoresistive (MR) element. This element is a layered structure with one or more layers of material exhibiting the magnetoresistive effect. The resistance of a magnetoresistive element changes when the element is in the presence of a magnetic field. Data bits are stored on the disk as small, magnetized region on the disk. As the disk passes by beneath the surface of the magnetoresistive material in the read head, the resistance of the material changes and this change is sensed by the disk drive control circuitry.

The write portion of a read/write head is typically fabricated using a coil embedded in an insulator between a top and bottom magnetic layer. The magnetic layers are arranged as a magnetic circuit, with pole tips forming a magnetic gap at the air bearing surface (ABS) of the head. When a data bit is to be written to the disk, the disk drive circuitry sends current through the coil creating a magnetic flux. The magnetic layers provide a path for the flux and a magnetic field generated at the pole tips magnetizes a small portion of the magnetic disk, thereby storing a data bit on the disk.

Stated differently, data is written onto a disk by a write head that includes a magnetic yoke having a coil passing therethrough. When current flows through the coil, a magnetic flux is induced in the yoke, which causes a magnetic field to fringe out at a write gap in a pole tip region. It is this magnetic field that writes data or data bits, in the form of magnetic transitions, onto the disk. Such heads are typically thin film magnetic heads, constructed using material deposition techniques such as sputtering and electroplating, along with photolithographic techniques and wet and dry etching techniques.

The read/write head is formed by deposition of magnetic, insulating and conductive layers using a variety of techniques. Fabrication of the write head coil requires a metallization step wherein the metallization is formed in the shape of a coil. The damascene process is one of the techniques used for forming metallization layers in integrated circuits. Generally, the damascene process involves forming grooves or trenches in a material, and then electroplating to fill the trenches with metal. After a trench is formed, however, a seed layer must first be deposited in the trench to provide an electrically conductive path for the ensuing electrodeposition process. Metal is then deposited over the entire area so that the trench is completely filled. The damascene process used in semiconductor device fabrication requires fewer process steps compared to other metallization technologies. To achieve optimum adherence of the conductor to the sides of the trench, the seed layer deposited prior to deposition of the metal must be continuous and essentially uniform.

The increasing demand for higher data rate has correspondingly fueled the reduction of the yoke length, coil pitch and hence the overall head structure. This allows for higher speeds (rpm) disk drives having high performance. In addition to a compact design of the yoke (shorter yoke), low coil resistance is desirable for which damascene techniques are used to form a thick coil in a compact area. In damascene techniques, hard baked photoresist, used as a medium, onto which coil is formed. However, control of the change in the shape of the baked photoresist provides no guarantee of forming compact coil over the area that is needed to photoresist and due to the necessity for tight tolerances in compact coil formation, the former is unacceptable. Stated differently, applying photoresist and baking it results in unpredictable changes in the shape of the baked photoresist material and then when coil is formed thereupon, uncontrollable dimensions of the coil lead to lack of compact coil formation. During the hard bake process of the photoresist material, the photoresist has a tendency to shrink, which causes the edges of the resist coil pattern to slope. Compact designs require tight tolerances, thus, currently, sufficient compact coil area using damascene techniques is virtually unattainable.

One method currently employed for forming a compact coil under tight tolerances is to use large photoresist but due to tight tolerances, the photoresist is exposed at the ABS, in finished slider form, which is unacceptable because it causes unrecoverable disk drive performance issues. This is shown pictorially relative to FIGS. 1 and 2.

In FIG. 1, relevant portions of a prior art disk drive 10 is shown to include a photoresist 14 onto which a coil 12 is formed having a center tap 16. A P1 pedestal layer 20 is shown formed below the bottom of the photoresist 14 at the ABS 18. A back gap layer 22 is shown below the center tap 16 surrounded by the coil 12. In fact, the coil 12 is formed between the P1 pedestal layer 20 and the back gap layer 22 forming a yoke.

While a large area consuming the photoresist 14 is employed to meet the tight tolerances for a compact coil, the photoresist, when baked, while adhering to the P1 pedestal layer 20 after baking, slopes where the P1 pedestal layer 20 is not present. This is perhaps better understood relative to FIG. 2 where a cross sectional view, at AA, of the disk drive 10 of FIG. 1, is shown at 90. Coil turns 86 form the coil 12 of FIG. 1 and the insulators 88 shown between the coil turns 86 form the photoresist 14 of FIG. 1. A first pole P1 is shown on top of which is disposed the back gap layer 22, the coil turns 86 and the insulators 88. The last insulator 92 on the opposite side of the back gap layer 22 is shown to slope at the ABS thereby exposing the photoresist at the ABS, in finished slider form, which is unacceptable because it causes unrecoverable disk drive performance issues.

Thus, there is a need for forming a coil in a compact area of a magnetic head using damascene process.

### SUMMARY OF THE INVENTION

To overcome the limitations in the prior art described above, and to overcome other limitations that will become apparent upon reading and understanding the present specification, the present invention discloses a method for forming a coil in a compact area using a damascene process.

The present invention solves the above-described problems by providing, in one embodiment of the present invention, a write head including a P1 pedestal layer, a back gap layer, a coil formed between the P1 pedestal layer and the back gap layer, a hard bake photoresist formed above the P1 pedestal layer, and a hard bake photoresist barrier extending from and on either side of the P1 pedestal layer, wherein the hard bake photoresist barrier acts as a ‘dam’ for the hard bake photoresist to adhere to during manufacturing of the write head.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of embodiments of the present invention.

### BRIEF DESCRIPTION OF THE DRAWINGS

Referring now to the drawings in which like reference numbers represent corresponding parts throughout:

FIG. 1 shows relevant portions of a prior art disk drive 10;

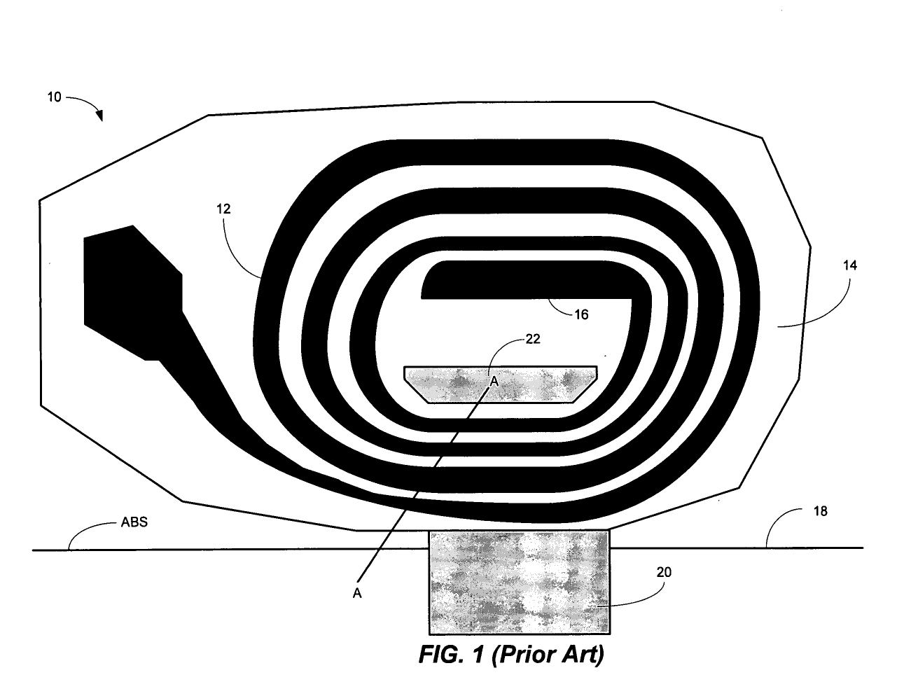

FIG. 2 shows a cross section view of the prior art disk drive 10, at AA of FIG. 1;

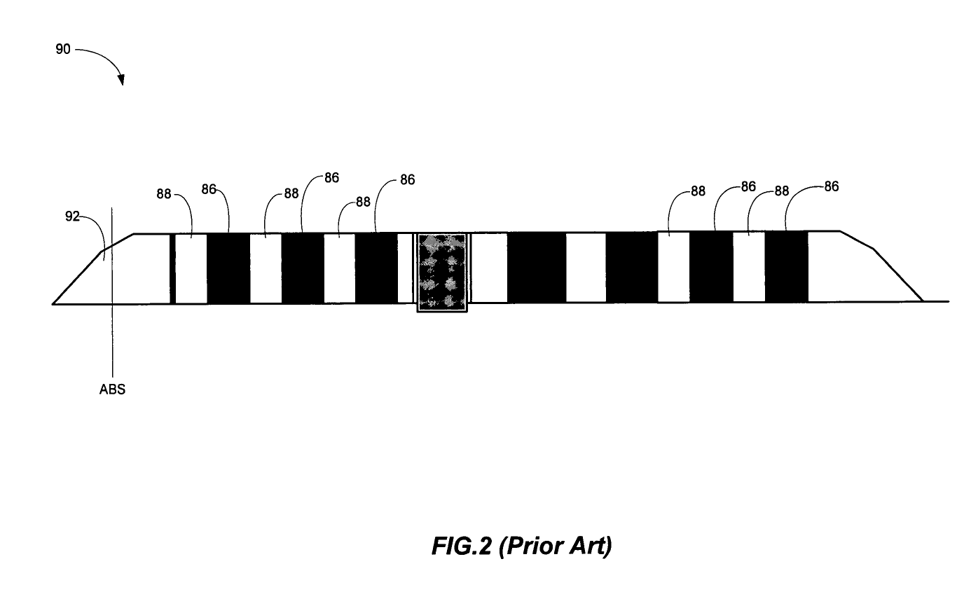

FIG. 3 illustrates a storage system according to the present invention;

FIG. 4 illustrates one particular embodiment of a storage system according to the present invention;

FIG. 5 illustrates a disk drive system according to the present invention;

FIG. 6 is an isometric illustration of a suspension system for supporting a slider and a magnetic head;

FIG. 7 illustrates a top view of the relevant portions of the write head 700 of the hard disk drive 230 of FIG. 4, in accordance with an embodiment of the present invention;

FIG. 8 shows a cross sectional view, at BB of the write head 700 of FIG. 7;

FIGS. 9(a)-(f) illustrate the method for patterning a coil using a damascene process according to an embodiment of the present invention;

FIG. 10 illustrates a top view of the relevant portions of a write head 1000, in accordance with another embodiment of the present invention;

FIG. 11 shows a cross section view of the write head 1000 of FIG. 10;

FIG. 12 shows a top view of the relevant portions of a write head 1200, in accordance with yet another embodiment of the present invention; and

FIG. 13 shows a cross section view of the write head 1200 of FIG. 12.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The present invention provides an apparatus and method for forming a coil in a compact area of a magnetic head using damascene process. A P1 pedestal layer of the magnetic recording (or write) head is utilized to form hard baked photoresist barriers in a coil pattern consistent with the shape of the coil that will be formed. These barriers will be formed as part of the P1 pedestal layer and will act as a ‘dam’ for the photoresist to flow up against and adhere to during the hard bake process yielding a consistent, compact open area for the damascene coil to be formed. This also results in thick coil formed in a compact area and having lower resistance.

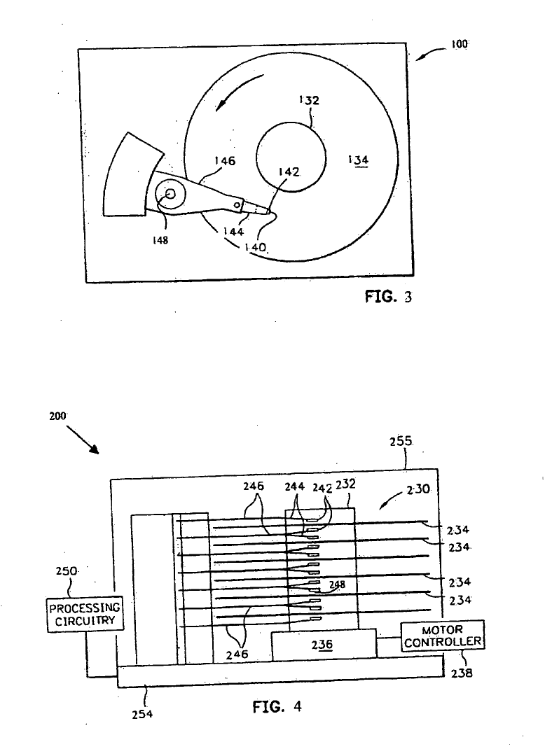

FIG. 3 illustrates a storage system 100 according to the present invention. In FIG. 3, a transducer 140 is under control of an actuator 148. The actuator 148 controls the position of the transducer 140. The transducer 140 writes and reads data on magnetic media 134 rotated by a spindle 132. A transducer 140 is mounted on a slider 142 that is supported by a suspension 144 and actuator arm 146. The suspension 144 and actuator arm 146 positions the slider 142 so that the magnetic head 140 is in a transducing relationship with a surface of the magnetic disk 134.

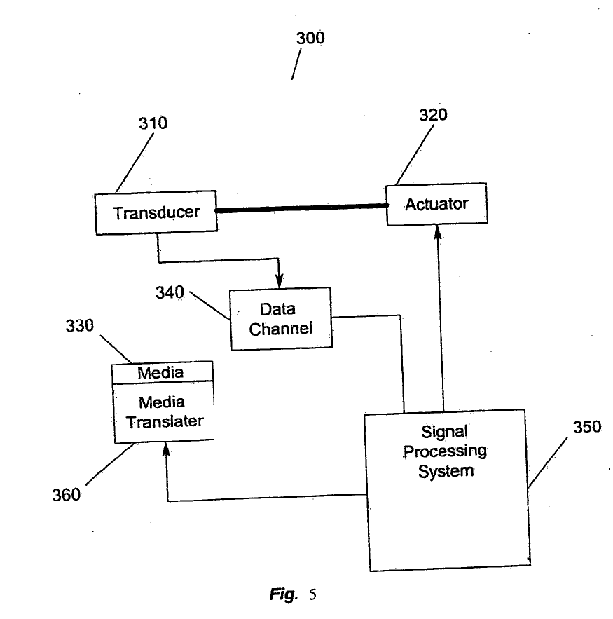

FIG. 4 illustrates one particular embodiment of a storage system 200 according to the present invention. In FIG. 4, a hard disk drive 230 is shown. The drive 230 includes a spindle 232 that supports and rotates magnetic disks 234. A motor 236, mounted on a frame 254 in a housing 255, which is controlled by a motor controller 238, rotates the spindle 232. A combined read and write magnetic head is mounted on a slider 242 that is supported by a suspension 244 and actuator arm 246. Processing circuitry 250 exchanges signals, representing such information, with the head, provides motor drive signals for rotating the magnetic disks 234. and provides control signals for moving the slider to various tracks. The plurality of disks 234, sliders 242 and suspensions 244 may be employed in a large capacity direct access storage device (DASD).

When the motor 236 rotates the disks 234 the slider 242 is supported on a thin cushion of air (air bearing) between the surface of the disk 234 and the air bearing surface (ABS) 248. The magnetic head may then be employed for writing information to multiple circular tracks on the surface of the disk 234, as well as for reading information therefrom.

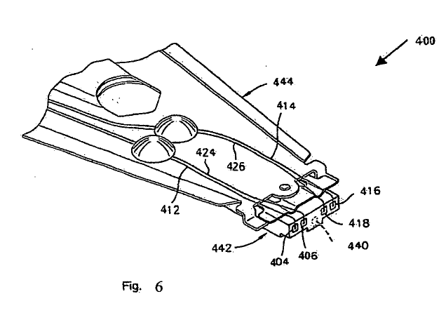

FIG. 5 illustrates a storage system 300. In FIG. 5, a transducer 310 is under control of an actuator 320. The actuator 320 controls the position of the transducer 310. The transducer 310 writes and reads data on magnetic media 330. The read/write signals are passed to a data channel 340. A signal processor system 350 controls the actuator 320 and processes the signals of the data channel 340. In addition, a media translator 360 is controlled by the signal processor system 350 to cause the magnetic media 330 to move relative to the transducer 310. Nevertheless, the present invention is not meant to be limited to a particular type of storage system 300 or to the type of media 330 used in the storage system 300.

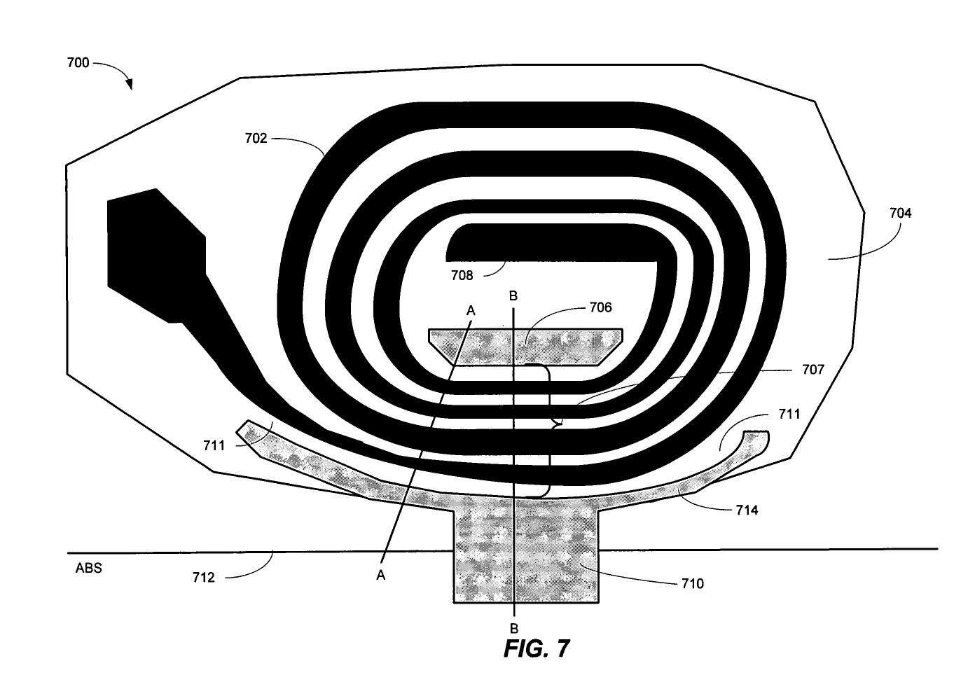

FIG. 6 is an isometric illustration of a suspension system 400 for supporting a slider 442 having a magnetic head mounted thereto. In FIG. 6, first and second solder connections 404 and 406 connect leads from the sensor 440 to leads 412 and 424 on the suspension 444 and third and fourth solder connections 416 and 418 connect the coil to leads 414 and 426 on the suspension 444. However, the particular locations of connections may vary depending on head design.

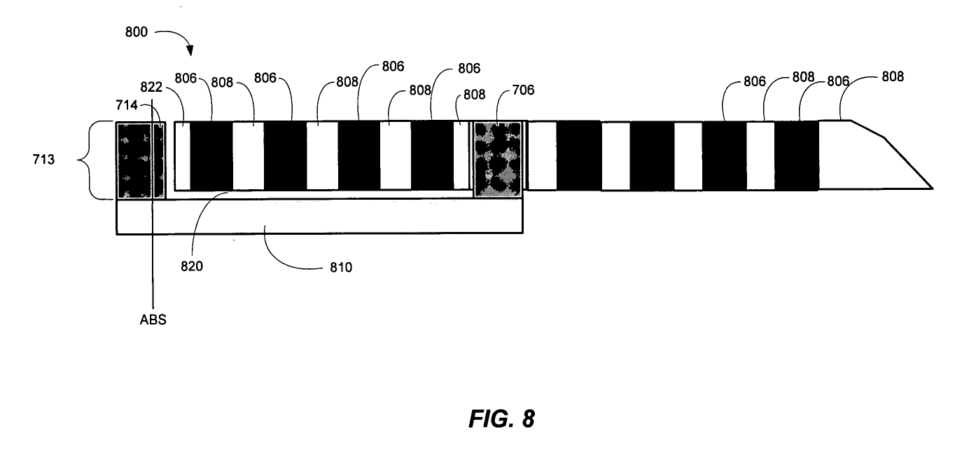

FIG. 7 illustrates a top view of the relevant portions of the write head 700 of the hard disk drive 230 of FIG. 4, in accordance with an embodiment of the present invention. To provide perspective, the write head 700 is a part of the slider referred to and discussed in FIGS. 3-6, operational in a disk drive, such as the hard disk drive 230. FIG. 7 shows a coil 702 formed between a P1 pedestal layer 710 and a back gap layer 706. A hard bake photoresist 704 isolates the coil windings of the coil 702. The coil 702 includes a center tap 708 at its inner-most winding and disposed on top of the back gap layer 706. The P1 pedestal 710 on top of which the hard bake photoresist 704 is disposed is shown at an ABS 712. The P1 pedestal 710 is shown to have a modified shape relative to prior art structures in that a hard baked photoresist barrier 714 extends above and on either side of the P1 pedestal layer 710, in a partial concave shape forming a semi-circular shape above the P1 pedestal layer 710, similar to the horns of an antelope. The barrier 714 may be made of magnetic or non-magnetic material. Examples of the composition of the barrier 714 include but are not limited to: NiFe permolloy (22% Ni and 78% Fe), (45% Ni and 55% Fe), (80% Ni and 20% Fe) or (32% Ni and 68% Fe); CoFe; or CoFeNi or various compositions of permalloy. Although the dimensions of the barrier 714 can vary, a length as short as possible is preferred. In one example, the length of the barrier 714 is approximately 20 um and its width is 2 um.

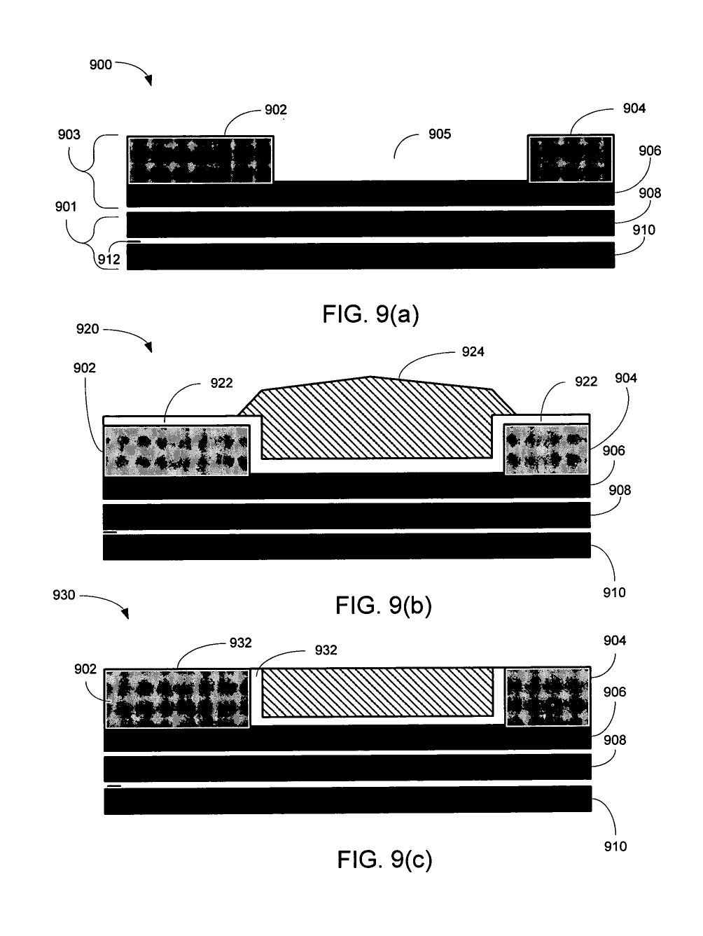

The hard bake photoresist 704, when baked during the manufacturing of the write head 700, pulls back or shrinks but in prior art techniques, the shrinking was uncontrolled, whereas, in the present invention, the shrinking is controlled such that the hard bake photoresist 704 is guaranteed to consistently pull back behind the ABS, as shown at 711, in FIG. 7. This is done in light of a short yoke length, the yoke length being shown at 707, in FIG. 7. That is, the barrier 714 acts as a ‘dam’ for the hard bake photoresist to adhere to during the baking process allowing the outer-most turn of the coil to be formed properly by eliminating the undesired slope of the hard bake photoresist or insulator. This can perhaps better be seen with reference to FIG. 8, which shows a cross sectional view, at BB of the write head 700 of FIG. 7. It is important to note that during manufacturing, the barrier 714 is formed prior to the filling in of the photoresist 704 and even if there is spillage or overlap of the photoresist 704 over the barrier 714, the subsequent steps of alumina fill and CMP clean the spillage so that tight tolerances are met. In the case of self-aligned coil, the barrier 714 is shaped to the requisite shape of the coil.

Thus, in the present invention barriers are employed for the hard bake photoresist to be exposed around and have direct contact with and when the latter is baked and the shape thereof attempts to change, the hard bake photoresist would cling to the surfaces of the barrier(s) leading to control of the shape of the photoresist. This, in essence, causes a darning effect by the P1 pedestal layer.

In FIG. 8, the barrier 714: of the P1 pedestal 710, of FIG. 7, is shown disposed at the air bearing surface (ABS) and a first back gap layer 706, at an opposite end, are formed over a first pole P1 810. The first pole P1 810, the P1 pedestal layer 714, and the back gap layer 706 are formed of a magnetic material such as for example NiFe. A gap layer 820 is shown formed over the first pole P1 810 between the P1 pedestal 714 and the back gap layer 706.

In FIG. 8, coil turns 806 form the coil 702 of FIG. 7 and the insulators 808 shown disposed between the coil turns 806 form the photoresist 704 of FIG. 7. The first pole P1 810 is shown on top of which is disposed the back gap layer 706, the coil turns 806 and the insulators 808. The last insulator 822 on the opposite side of the back gap layer 706 is shown not to slope at the ABS, rather, well controlled while allowing for coil turns 806 to fit into a compact space. In an exemplary embodiment, the thickness of each of the coil turns 806 is approximately 1 um and the thickness of each of the insulators 808 is 0.3 or 0.4 um. To provide prespective, the depth of the barrier 714, shown in FIG. 8 at 713, is approximately 4.5 um, in an example embodiment, which contributes to the length of the yoke being relatively short requiring a compact area in which thick coils are expected to be patterned. As previously shown and discussed, the insulator 822 is guaranteed to consistently pull back behind (or to the right of) the ABS, in FIG. 8.

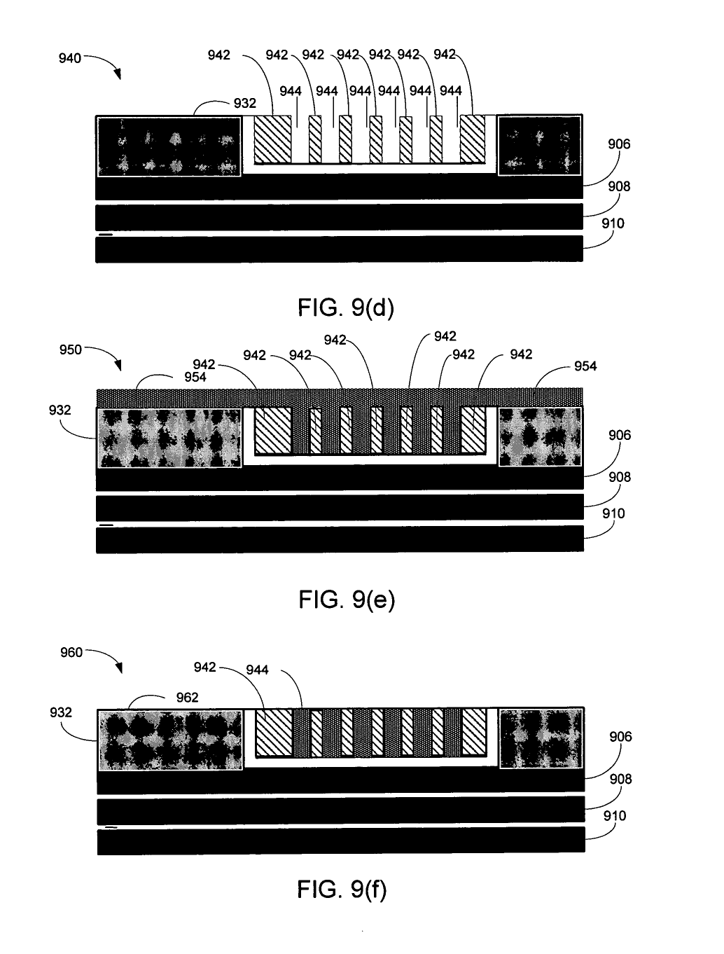

FIGS. 9(a)-(f) illustrate the method for patterning a coil using a damascene process according to an embodiment of the present invention. In FIG. 9(a), a portion of a magnetic transducer 900 is shown to include a read head 901 and a write head 903, the read head 901 including a first shield layer 910, a magnetoresistive (MR) element (read sensor) 912 and the second shield layer 908. The read sensor 912 is shown disposed between the first 910 and second shields 908. The read sensor 912 may be an AMR element, a GMR element or any other magnetoresistive element.

In FIG. 9(a), the write head 903 is shown to include a first pole P1 906 disposed above the second shield 908 of the read head 901 and a P1 pedestal layer 902 formed on a front end and a back gap layer 904 on an opposing or back end of the transducer 900 and above the P1 906. A gap 905 is shown to be the top part of the P1 906 onto which no layer is yet formed and thus separates the P1 pedestal layer 902 and the back gap layer 904.

The P1 pedestal layer 902 is built by placing a layer of metal across an entire wafer, then, a photolithography pattern is performed to provide the shapes of, for example, the P1 pedestal layer 902, and then, the pattern is placed in an electroplating bath and then plating is performed to remove areas where the photoresist is not open. In other words, in the places where the photoresist is present, no plating is performed whereas in areas where the photoresist is not present, plating results. Next, the photoresist is stripped away using solvents and then plasma etching is performed, bombarding the surface, to remove the metal material that remained unplated. The result is the P1 pedestal layer 902 shown in FIG. 9(a).

FIG. 9(b) shows the step 920 of depositing a first non-magnetic, non-conductive material 922, such as Al₂O₃, in the gap 905 between the back gap layer 904 and the P1 pedestal layer 902. A hard bake photoresist 924 is deposited to fill the gap 905 and above the layer 922 and it is cured by baking. Next, in FIG. 9(c) at step 930, the hard bake photoresist 924 is polished via CMP to the height 932 of the first non-magnetic, non-conductive material 922 on the P1 pedestal layer 902 and back gap layer 904. Alumin filling is performed because photoresist is patterned in only certain areas, thus, the areas that are not patterned, are filled with other material, such as alumina (Al₂O₃). Polishing the entire surface flat as is done by CMP, a two-dimensional area is created in which coil is formed, as the coil must be formed on photoresist and cannot be formed on alumina because it simply will not form.

CMP (Chemical Mechanical Planarization) is the process by which a surface is made even by removal of material from any uneven topography. As its name indicates, CMP is a combination of a mechanical polishing with a chemistry that includes abrasives and either an acid or base to achieve the desired effects.

Next, at step 940, in FIG. 9(d), coil 942 is patterned, leaving spaces 944 between coil turns for insulation, and reactive ion etching is performed etching the coil pattern from the photo stencil into a hard baked photoresist.

Next, at step 950, in FIG. 9(e), a seed layer 954 is deposited over the P1 pedestal layer 902, the back gap layer 904, the layer 922, the coil 942 and the spaces between the coil 942 and the spaces 944. Next, damascene plating is performed to fill and plate up over the foregoing structures.

Formation of the coil element is accomplished using a damascene process with self-aligned coil or non-self-aligned coil. A damascene process is a process in which metal structures are delineated in dielectrics isolating them from each other not by means of lithography and etching, but by means of chemical-mechanical planarization (CMP). In this process, an interconnect pattern is first lithographically defined in the layer of dielectric, metal is deposited to fill resulting trenches and then excess metal is removed by means of chemical-mechanical polishing (planarization).

The self-aligned damascene process allows grooves to be formed in an insulating layer and filled with metal to form conductive windings having the maximizing amount of copper deposited in the coil pocket and reduced coil resist line. For a better understanding of self-aligned coil patterning using damascene process, the reader is referred to U.S. patent application Ser. No. 10/652,878, filed on Aug. 29, 2003, entitled “Method For Patterning A Self-Aligned Coil Using A Damascene Process”, by Bedell et al. and U.S. patent application Ser. No. 10/652,877, filed on Aug. 29, 2003, entitled “Apparatus For Patterning A Self-Aligned Coil Using A Damascene Process”, by Bedell et al., the disclosures of which are incorporated herein by reference, as though set forth in full. While the foregoing patent documents discuss self-aligned coil, it should be understood that the teachings of the present invention equally apply to non-self-aligned coils.

Lastly, in FIG. 9(f), at step 960, polishing is performed using CMP to flatten the surface of the foregoing structures to the height 962. The steps described above are similar to those performed for damascene processes with no added steps required, however, the shape of the P1 pedestal layer 902 is changed to include the barrier 714, which is not shown relative to FIG. 7 and/or other figures representing different embodiments thereof to be discussed.

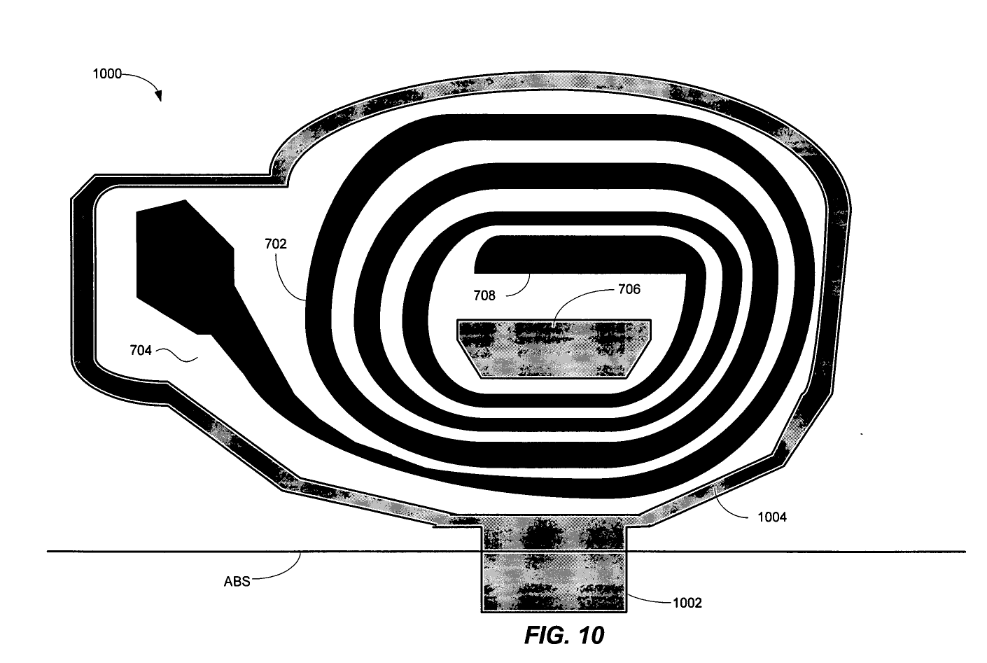

FIG. 10 shows a top view of the relevant portions of a write head 1000, in accordance with another embodiment of the present invention. The write head 1000 is shown to include the structures of FIG. 7 except that a P1 pedestal layer 1002 is shown to have a hard bake photoresist barrier 1004 wrapped around the entire photoresist 704 as opposed to partially holding the latter in place, as shown in FIG. 7. The write head 1000 is particularly useful for short yoke length designs where tighter tolerances for building the layers comprising the write head are needed. That is, with a barrier wrapped all the way around the hard bake photoresist, there is even further control of the shrinkage of the latter when baked. The composition of the barrier 1004 is the same as that discussed relative to the barrier 714 of FIG. 7.

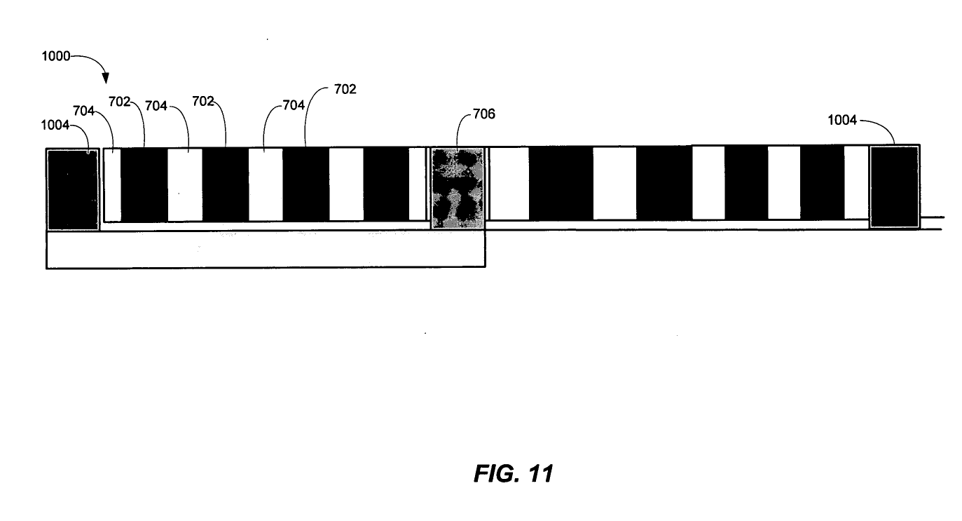

FIG. 11 shows a cross section view of the write head 1000 of FIG. 10. In FIG. 11, it should be noted that due to the wrap around of the barrier 1004, the last structure shown at the right-most part of the write head, is a part of the barrier 1004, as opposed to insulation of the write head 700.

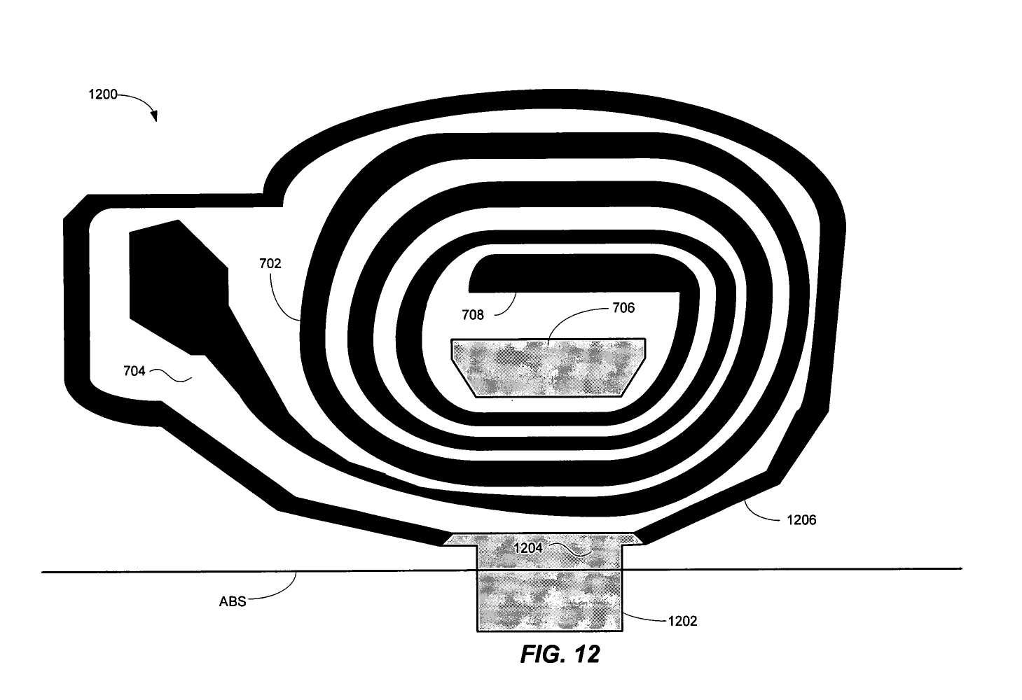

FIG. 12 shows a top view of the relevant portions of a write head 1200, in accordance with yet another embodiment of the present invention wherein a metal barrier 1206 is wrapped around the photoresist 704 in an area other than that which is directly on top of the P1 pedestal layer 1202. The portion of the barrier 1206 that is not necessarily made of copper is shown as partial barrier 1204. The barrier 1206 and partial barrier 1204 are a part of the P1 pedestal layer 1202. The metal barrier 1206 however, adds a step during manufacturing of the write head 1200.

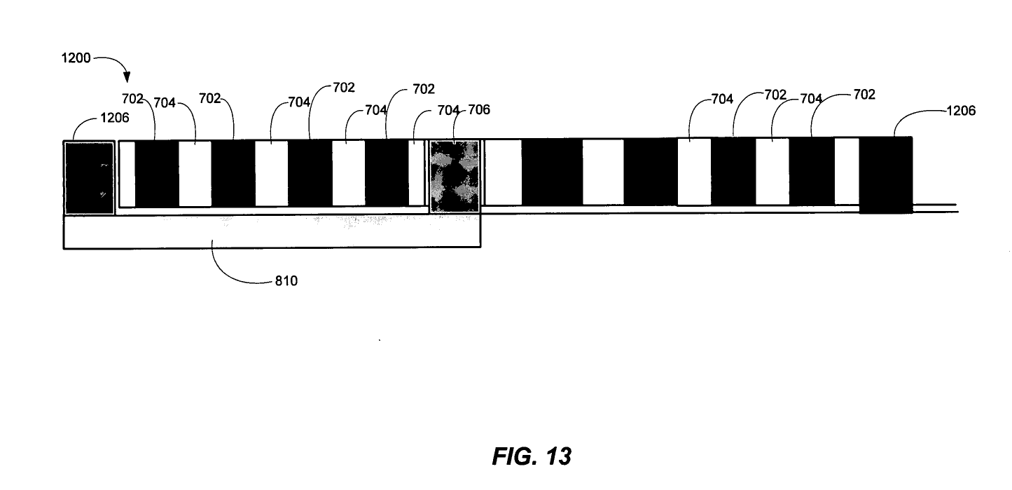

FIG. 13 shows a cross section view of the write head 1200 of FIG. 12. In FIG. 13, it should be noted that due to the wrap around of the barrier 1206, the last structure shown at the right-most part of the write head, is a part of the barrier 1206, as opposed to insulation of the write head 700.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A write head comprising:
a P1 pedestal layer;
a back gap layer;
a coil formed between the P1 pedestal layer and the back gap layer;
a hard bake photoresist formed above the P1 pedestal layer; and
a hard bake photoresist barrier extending from and on either side of the P1 pedestal layer,
wherein hard bake photoresist barrier acts as a ‘dam’ for the hard bake photoresist to adhere to during manufacturing of the write head.

2. A write head, as recited in claim 1, wherein the hard bake photoresist barrier is made of a non-magnetic material.

3. A write head, as recited in claim 1, wherein the hard bake photoresist barrier is made of a magnetic material.

4. A write head, as recited in claim 3, wherein the hard bake photoresist barrier is made of a magnetic material selected from a group consisting of: NiFe, CoFe; and CoFeNi.

5. A write head, as recited in claim 1, wherein the coil is self-aligned.

6. A write head, as recited in claim 1, wherein the hard bake photoresist barrier wraps all the way around the hard bake photoresist encompassing the same.

7. A write head, as recited in claim 1, wherein a metal material extends beyond the hard bake photoresist barrier wrapping around the hard bake photoresist.

8. A write head, as recited in claim 7, wherein the metal material is made of copper.

9. A hard disk drive comprising:
a write head including,
a P1 pedestal layer;
a back gap layer;
a coil formed between the P1 pedestal layer and the back gap layer;
a hard bake photoresist formed above the P1 pedestal layer; and
a hard bake photoresist barrier extending from and on either side of the P1 pedestal layer,
wherein hard bake photoresist barrier acts as a ‘dam’ for the hard bake photoresist to adhere to during manufacturing of the write head.

10. A disk drive, as recited in claim 9, wherein the hard bake photoresist barrier is made of a non-magnetic material.

11. A disk drive, as recited in claim 9, wherein the hard bake photoresist barrier is made of a magnetic material.

12. A disk drive, as recited in claim 11, wherein the hard bake photoresist barrier is made of a magnetic material selected from a group consisting of: NiFe, CoFe; and CoFeNi.

13. A disk drive, as recited in claim 9, wherein the coil is self-aligned.

14. A disk drive, as recited in claim 9, wherein the hard bake photoresist barrier wraps all the way around the hard bake photoresist encompassing the same.

15. A disk drive, as recited in claim 9, wherein a metal material extends beyond the hard bake photoresist barrier wrapping around the hard bake photoresist.

16. A disk drive, as recited in claim 15, wherein the metal material is made of copper.

17. A write head comprising:
a P1 pedestal layer;
a back gap layer;
a coil formed between the P1 pedestal layer and the back gap layer;
a hard bake photoresist formed above the P1 pedestal layer; and
a barrier means extending from and on either side of the P1 pedestal layer,
wherein the barrier means acts as a ‘dam’ for the hard bake photoresist to adhere to during manufacturing of the write head.
